(19) United States
(12) Patent Application Publication
(10) Pub. No.: US 2023/0375776 A1
(43) Pub. Date: Nov. 23, 2023

(54) ILLUMINATION DEVICE AND DISPLAY DEVICE

(71) Applicant: Japan Display Inc., Tokyo (JP)

(72) Inventors: Hiroaki KIJIMA, Tokyo (JP); Shinichi KOMURA, Tokyo (JP); Ken ONODA, Tokyo (JP); Koichi OKUDA, Tokyo (JP)

(73) Assignee: Japan Display Inc., Tokyo (JP)

(21) Appl. No.: 18/364,564

(22) Filed: Aug. 3, 2023

Related U.S. Application Data
(63) Continuation of application No. PCT/JP2021/043101, filed on Nov. 25, 2021.

(30) Foreign Application Priority Data
Feb. 5, 2021 (JP) 2021-017746

(51) Int. Cl. F21V 8/00

(52) U.S. Cl. CPC G02B 6/0078; G02B 6/0068; G02B 6/0088; G02B 6/0036; F21V 2200/20

(57) ABSTRACT

According to one embodiment, an illumination device includes first and second light guides, first and second light sources, and first and second layers. The first light guide includes first and second main surfaces and first and second side surfaces. The second light guide includes third and fourth main surfaces and third and fourth side surfaces. The first light sources face a second side surface. The second light sources face the third side surface. The first layer includes first prisms in the second main surface. The second layer includes second prisms in the fourth main surface. The second and fourth side surfaces are displaced from each other in a first direction.

### CROSS-REFERENCE TO RELATED APPLICATIONS

This application is a Continuation Application of PCT Application No. PCT/JP2021/043101, filed Nov. 25, 2021 and based upon and claiming the benefit of priority from Japanese Patent Application No. 2021-017746, filed Feb. 5, 2021, the entire contents of all of which are incorporated herein by reference.

### FIELD

Embodiments described herein relate generally to an illumination device and a display device.

### BACKGROUND

For example, a display device such as a liquid crystal display device comprises a display panel comprising pixels, and an illumination device such as a backlight which illuminates the display panel. The illumination deice comprises a light source which emits light, and a light guide which is illuminated by the light emitted from the light source. The light emitted from the light source enters the light guide from a side surface of the light guide, passes through the light guide and is emitted from an emission surface equivalent to one of the main surfaces of the light guide.

For example, a configuration in which two light guides overlap each other is also known. In a case where two light guides overlap each other in this manner, if the illumination light emitted from the emission surface has non-uniformity in luminance, the quality of the image displayed by the display panel could be also degraded.

### BRIEF DESCRIPTION OF THE DRAWINGS

FIG. 1 is an exploded perspective view showing a configuration example of a display device according to one embodiment.

FIG. 2 is a plan view of the illumination device shown in FIG. 1.

FIG. 3 is a cross-sectional view of the display device shown in FIG. 1.

FIG. 4 is a diagram for explaining the shapes of a first layer and a second layer and is a perspective view of the illumination device shown in FIG. 3.

FIG. 5 is a fragmentary sectional view of the light guide, first layer and light source shown in FIG. 3.

FIG. 6 is a cross-sectional view near the center of a pair of light guides.

FIG. 7 is a cross-sectional view near a side surface of one of the light guides.

FIG. 8 is a cross-sectional view near the side surfaces of the pair of light guides.

FIG. 9 is a cross-sectional view showing the optical path of the light reflected by the prism of the second layer.

FIG. 10 is a cross-sectional view of an illumination device according to a comparative example.

FIG. 11 is a cross-sectional view showing a modified example of the present embodiment.

### DETAILED DESCRIPTION

In general, according to one embodiment, an illumination device comprises a first light guide, a second light guide, a plurality of first light sources, a plurality of second light sources, a first layer and a second layer. The first light guide comprises a first main surface, a second main surface located on an opposite side of the first main surface, a first side surface, and a second side surface located on an opposite side of the first side surface in a first direction. The second light guide comprises a third main surface facing the second main surface, a fourth main surface located on an opposite side of the third main surface, a third side surface which is close to the first side surface, and a fourth side surface which is located on an opposite side of the third side surface in the first direction and close to the second side surface. The first light sources face the second side surface and are arranged in a second direction intersecting with the first direction. The second light sources face the third side surface and are arranged in the second direction. The first layer includes a plurality of first prisms provided in the second main surface. The second layer includes a plurality of second prisms provided in the fourth main surface. The second side surface and the fourth side surface are displaced from each other in the first direction.

According to another aspect of the embodiment, a display device comprises the illumination device and a display panel which displays an image. Further, the display panel faces the first main surface.

For example, the embodiment can provide an illumination device and a display device which can prevent the non-uniformity in the luminance of illumination light.

Embodiments will be described hereinafter with reference to the accompanying drawings. The disclosure is merely an example, and proper changes in keeping with the spirit of the invention, which are easily conceivable by a person of ordinary skill in the art, come within the scope of the invention as a matter of course. In addition, in some cases, in order to make the description clearer, the widths, thicknesses, shapes, etc., of the respective parts are illustrated schematically in the drawings, rather than as an accurate representation of what is implemented. However, such schematic illustration is merely exemplary, and in no way restricts the interpretation of the invention. In addition, in the specification and drawings, structural elements which function in the same or a similar manner to those described in connection with preceding drawings are denoted by like reference numbers, detailed description thereof being omitted unless necessary.

In the present embodiment, as an example of a display device DSP, a transmissive liquid crystal display device is disclosed. As an example of an illumination device, an illumination device which is used as the backlight of a transmissive liquid crystal display device is disclosed. The main configuration disclosed in the present embodiment can be applied to liquid crystal display devices comprising a reflective function which reflects external light and uses the reflected light for display in addition to a transmissive function, electronic paper display devices comprising an electrophoretic element and the like, display devices to which micro-electromechanical systems (MEMS) are applied, display devices to which electrochromism is applied, etc. In addition, the main configuration disclosed in the present embodiment can be applied to illumination devices which are used for purposes other than blacklights.

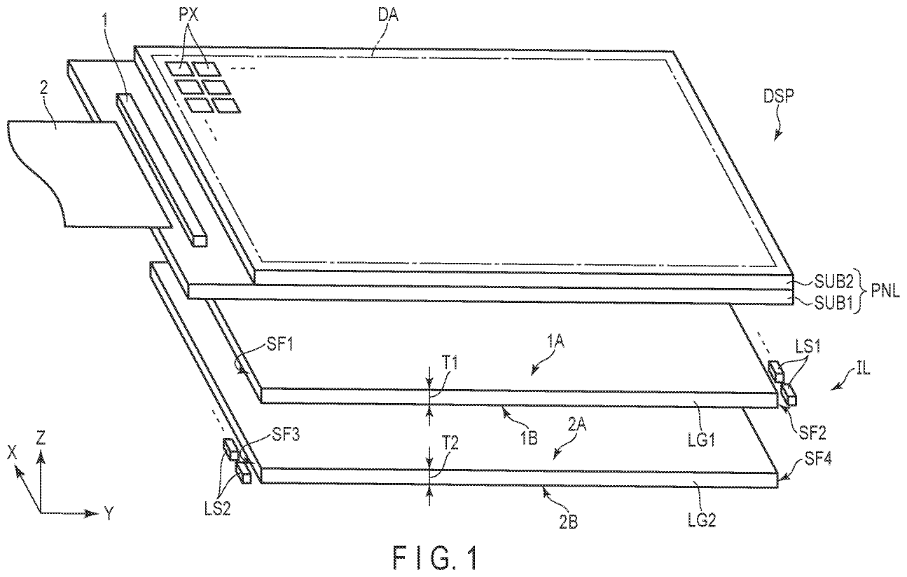

FIG. 1 is an exploded perspective view showing a configuration example of a display device DSP according to the present embodiment. As shown in FIG. 1, direction X, direction Y and direction Z are defined. Direction X, direction Y and direction Z are orthogonal to each other. However, they may intersect at an angle other than 90 degrees. Direction X and direction Y correspond to directions parallel to the main surfaces of the substrates constituting the display device DSP. Direction Z corresponds to the thickness direction of the display device DSP.

The display device DSP comprises a display panel PNL, an illumination device IL, an IC chip 1 and an interconnection substrate 2.

The display panel PNL comprises a first substrate SUB1 and a second substrate SUB2. The display panel PNL comprises a display area DA which displays an image. The display panel PNL comprises, for example, a plurality of pixels PX provided in matrix in the display area DA.

The IC chip 1 and the interconnection substrate 2 may read signals from the display panel PNL. However, they mainly function as signal sources which supply signals to the display panel PNL. For example, as shown in the figure, the IC chip 1 and the interconnection substrate 2 are mounted on, of the first substrate SUB1, the portion exposed from the second substrate SUB2. It should be noted that the IC chip 1 may be mounted on the interconnection substrate 2. The interconnection substrate 2 is, for example, a flexible printed board which can be bent.

The illumination device IL illuminates the display panel PNL. The illumination device IL comprises a light guide LG1, a light guide LG2, a plurality of light sources LS1 and a plurality of light sources LS2. The light guide LG2, the light guide LG1, the first substrate SUB1 and the second substrate SUB2 are arranged in this order in direction Z.

The light guide LG1 is formed into a flat-plate shape parallel to the X-Y plane defined by direction X and direction Y. The light guide LG1 comprises a main surface 1A facing the display panel PNL, a main surface 1B located on the opposite side of the main surface 1A in direction Z, a side surface SF1 and a side surface SF2 located on the opposite side of the side surface SF1 in direction Y. The main surfaces 1A and 1B are parallel to, for example, the X-Y plane. The side surface SF1 and the side surface SF2 are parallel to, for example, the X-Z plane defined by direction X and direction Z. The light guide LG1 has thickness T1. Thickness T1 is the length from the main surface 1A to the main surface lB in direction Z.

The light sources LS1 are arranged at intervals in direction X. Each light source LS1 faces the side surface SF2.

The light guide LG2 is formed into a flat-plate shape parallel to the X-Y plane. The light guide LG2 comprises a main surface 2A facing the main surface 1B, a main surface 2B located on the opposite side of the main surface 2A in direction Z, a side surface SF3 which is close to the side surface SF1 of the light guide LG1, and a side surface SF4 which is located on the opposite side of the side surface SF3 in direction Y and is close to the side surface SF2 of the light guide LG1. The main surfaces 2A and 2B are parallel to, for example, the X-Y plane. The side surfaces SF3 and SF4 are parallel to, for example, the X-Z plane. The light guide LG2 has thickness T2. Thickness T2 is the length from the main surface 2A to the main surface 2B in direction Z.

The light sources LS2 are arranged at intervals in direction X. Each light source LS2 faces the side surface SF3.

The light sources LS1 and the light sources LS2 are, for example, laser light sources such as semiconductor lasers which emit polarized laser beams. It should be noted that the light sources LS1 or the light sources LS2 do not necessarily emit laser beams. For example, the light sources LS1 and the light sources LS2 may be light emitting diodes.

Each of the light sources LS1 and the light sources LS2 may comprise a plurality of light emitting elements which emit light exhibiting different colors. For example, when each of the light sources LS1 and the light sources LS2 comprises three light emitting elements which emit red light, green light and blue light, respectively, the light exhibiting the mixed color of these colors (for example, white light) can be obtained.

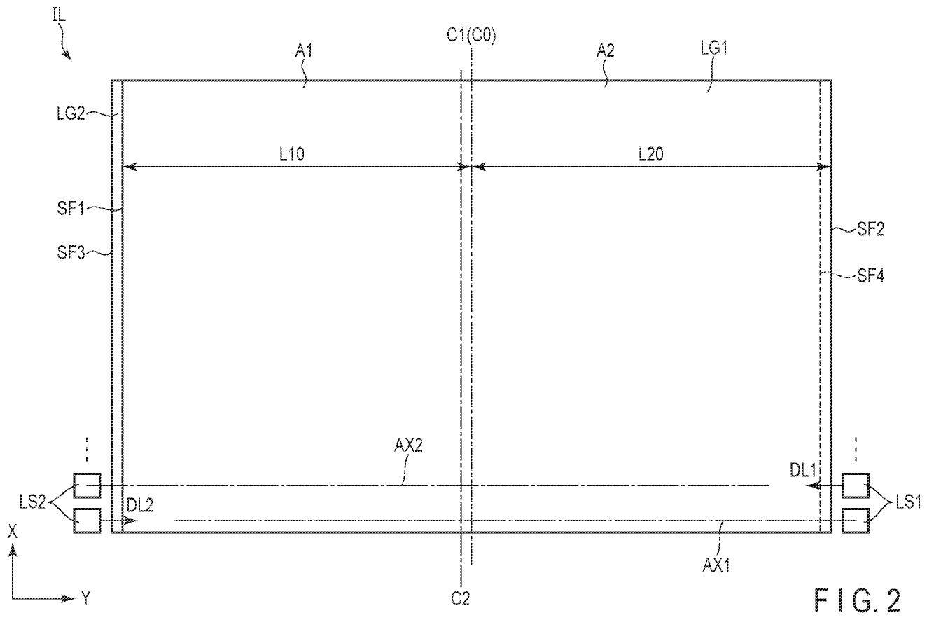

FIG. 2 is a plan view of the illumination device IL shown in FIG. 1. As shown in FIG. 2, the illumination device IL comprises first and second areas A1 and A2 arranged in direction Y. The first area A1 corresponds to, of the main surface 1A, the portion located between center C1 of the main surface 1A in direction Y and the side surface SF1. The second area A2 corresponds to, of the main surface 1A, the portion located between center C1 and the side surface SF2. In other words, length L10 of the first area A1 in direction Y is equal to length L20 of the second area A2 in direction Y.

In the example of FIG. 2, the light guide LG1 is a rectangle in which the side surface SF1 and the side surface SF2 are short sides. Similarly, the light guide LG2 is a rectangle in which the side surface SF3 and the side surface SF4 are short sides.

In the present embodiment, the light guide LG1 and the light guide LG2 have the same shape. In other words, the length of the light guide LG1 in direction Y is equal to the length of the second light guide LG2 in direction Y. The length of the light guide LG1 in direction X is also equal to the length of the second light guide LG2 in direction X. Further, thickness T1 is equal to thickness T2. It should be noted that the light guide LG1 and the light guide LG2 may have different shapes.

The light guide LG1 and the light guide LG2 are displaced from each other in direction Y. By this configuration, the side surface SF1 is not coincident with the side surface SF3 as seen in plan view. Similarly, the side surface SF2 is not coincident with the side surface SF4 as seen in plan view. In the example of FIG. 2, while the side surface SF1 overlaps the light guide LG2, the side surface SF2 does not overlap the light guide LG2.

Center C2 of the light guide LG2 in direction Y is located between center C1 and the side surface SF1. In the present embodiment, center C1 is coincident with center C0 of the display area DA in direction Y. In this case, when the illumination device IL is combined with the display panel PNL, the position adjustment of the main surface 1A (emission surface) of the light guide LG1 and the display panel PNL is easily performed. As another example, center C2 may be coincident with center C0.

The light guide LG1 is not misaligned with the light guide LG2 in direction X. In other words, of the light guide LG1, the pair of side surfaces parallel to direction Y is coincident with, of the light guide LG2, the pair of side surfaces parallel to direction Y, respectively, as seen in plan view.

The light sources LS1 emit light toward the side surface SF2 in emission direction DL1. The intensity of the light emitted from the light sources LS1 is the highest in optical axis AX1. Emission direction DL1 is parallel to optical axis AX1. The light sources LS2 emit light toward the side surface SF3 in emission direction DL2. The intensity of the light emitted from the light sources LS2 is the highest in optical axis AX2. Emission direction DL2 is parallel to optical axis AX2.

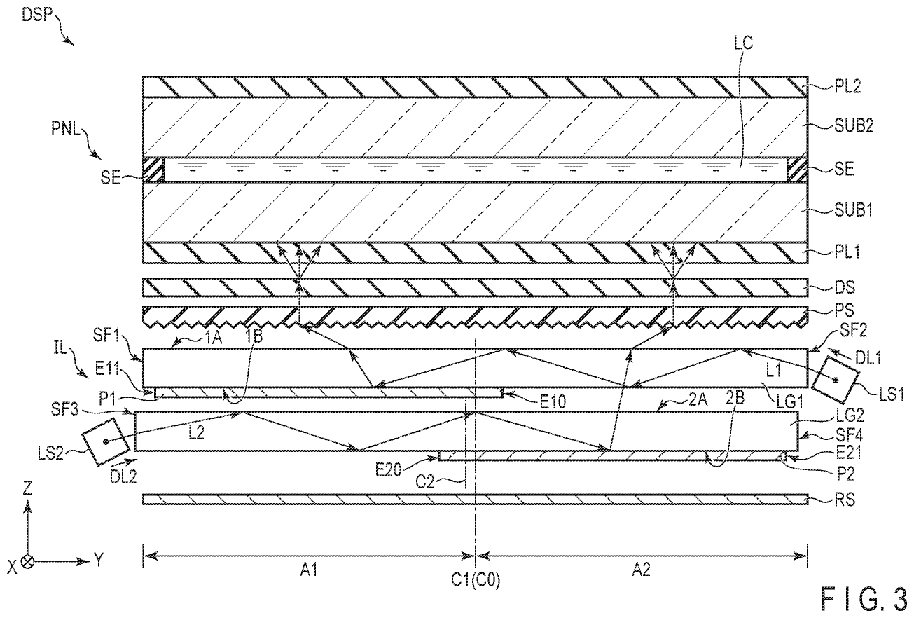

FIG. 3 is a cross-sectional view of the display device DSP shown in FIG. 1. As shown in FIG. 3, the display panel PNL further comprises a liquid crystal layer LC, a sealant SE, a polarizer PL1 and a polarizer PL2.

The liquid crystal layer LC and the sealant SE are located between the first substrate SUB1 and the second substrate SUB2. The first substrate SUB1 adheres to the second substrate SUB2 by the sealant SE. The liquid crystal layer LC is sealed in between the first substrate SUB1 and the second substrate SUB2 by the sealant SE.

The polarizer PL1 is attached to the lower surface of the first substrate SUB1. The polarizer PL2 is attached to the upper surface of the second substrate SUB2. The polarization axis of the polarizer PL1 and the polarization axis of the polarizer PL2 are, for example, orthogonal to each other.

The illumination device IL further comprises a first layer P1, a second layer P2, a diffusion sheet DS, a prism sheet PS and a reflective sheet RS. It should be noted that two prism sheets PS may be provided so as to overlap each other in direction Z.

The diffusion sheet DS is located between the display panel PNL and the light guide LG1. The diffusion sheet DS diffuses the light which enters the diffusion sheet DS and uniformizes the luminance of the light. The prism sheet PS is located between the diffusion sheet DS and the light guide LG1. For example, the prism sheet PS condenses the light emitted from the main surface 1A of the light guide LG1 into direction Z. The reflective sheet RS faces the main surface 2B of the light guide LG2. For example, the reflective sheet RS reflects the light leaking out of the light guide LG2 and causes the light to enter the light guide LG2 again.

Each of the first layer P1 and the second layer P2 is a layer including a plurality of prisms as described later. The first layer P1 is located in the main surface 1B. The first layer P1 overlaps a large part of the first area A1 and also overlaps part of the second area A2.

The first layer P1 comprises an end portion E10, and an end portion E11 on the opposite side of the end portion E10. The end portion E10 is located between center C1 and the side surface SF2 and is close to center C1. The end portion E11 is located between center C1 and the side surface SF1 and is close to the side surface SF1. For example, the end portion E10 corresponds to the position of, of the prisms included in the first layer P1 (the prisms PA described later), the prism closest to the side surface SF2. For example, the end portion E11 corresponds to the position of, of the prisms included in the first layer P1 (the prisms PA described later), the prism closest to the side surface SF1.

The second layer P2 is located in the main surface 2B. The second layer P2 overlaps a large part of the second area A2 and also overlaps part of the first area A1. The second layer P2 comprises an end portion E20, and an end portion E21 on the opposite side of the end portion E20. The end portion E20 is located between center C1 and the side surface SF3 and is close to center C1. The end portion E21 is located between center C1 and the side surface SF4 and is close to the side surface SF4. For example, the end portion E20 corresponds to the position of, of the prisms included in the second layer P2 (the prisms PB described later), the prism closest to the side surface SF3. For example, the end portion E21 corresponds to the position of, of the prisms included in the second layer P2 (the prisms PB described later), the prism closest to the side surface SF4.

The first layer P1 and the second layer P2 overlap each other in center C1 (center C0) and center C2 in direction Z. In the present embodiment, the first layer P1 and the second layer P2 have the same shape. In other words, the length of the first layer P1 in direction Y is equal to the length of the second layer P2 in direction Y.

The light sources LS1 are spaced apart from the side surface SF2. Emission direction DL1 of the light sources LS1 is a direction intersecting with the normal direction of the side surface SF2. The light sources LS2 are spaced apart from the side surface SF3. Emission direction DL2 of the light sources LS2 is a direction intersecting with the normal direction of the side surface SF3.

Light L1 emitted from the light sources LS1 is refracted on the side surface SF2 and enters the light guide LG1. Of light L1 which entered the light guide LG1, the light which travels toward the main surface 1A is reflected on the interface between the light guide LG1 and an air layer. Of light L1 which entered the light guide LG1, the light which travels toward the main surface 1B is reflected on the interface between the light guide LG1 and an air layer. In this manner, light L1 travels inside the light guide LG1 while repeating reflection in the region in which the first layer P1 is not provided in the second area A2.

The traveling direction of, of light L1 which travels inside the light guide LG1, the light which travels from the light guide LG1 to the first layer P1 is changed by the prisms of the first layer P1. This light is emitted from the main surface 1A as it is out of the conditions for the total reflection of the main surface 1A. The light emitted from the main surface 1A illuminates the display panel PNL via the prism sheet PS and the diffusion sheet DS. In other words, in the region in which the first layer P1 is not provided in the second area A2, the phenomenon in which light L1 emitted from the side surface SF2 is emitted from the light guide LG1 to the display panel PNL is prevented.

Similarly, light L2 emitted from the light sources LS2 is refracted on the side surface SF3 and enters the light guide LG2. In the region in which the second layer P2 is not provided in the first area A1, light L2 travels inside the light guide LG2 while repeating reflection on the main surface 2A and the main surface 2B. The traveling direction of, of light L2 which travels inside the light guide LG2, light L2 which travels from the light guide LG2 to the second layer P2 is changed by the prisms of the second layer P2. This light is emitted from the main surface 2A as it is out of the conditions for the total reflection of the main surface 2A. The light emitted from the main surface 2A illuminates the display panel PNL via the light guide LG1, the prism sheet PS and the diffusion sheet DS. In other words, in the region in which the second layer P2 is not provided in the first area A1, the phenomenon in which light L2 emitted from the side surface SF3 is emitted from the light guide LG2 to the display panel PNL is prevented.

In the first area A1, the display panel PNL is mainly illuminated by light L1 emitted from the light sources LS1. In the second area A2, the display panel PNL is mainly illuminated by light L2 emitted from the light sources LS2.

In general, the light beam emitted from each of a plurality of light sources arranged at intervals travels inside a light guide while diffusing. However, these light beams are not sufficiently mixed with each other near the light sources. For this reason, in a display device which uses these light beams as illumination light, streaky non-uniformity in luminance or chromaticity deviation may be visually recognized because of the difference in intensity when the display area is seen in plan view. The difference in the intensity of illumination light is decreased with increasing distance from the light sources.

In the present embodiment, in the region in which the first layer P1 is not provided in the second area A2, light L1 from the side surface SF2 is trapped in the light guide LG1, and the incidence of the light on the display panel PNL is prevented. In the second area A2, light L1 from the light sources LS1 does not substantially enter the display panel PNL while light L2 from the light sources LS2 illuminates the display panel PNL. The first area A1 is sufficiently far from the side surface SF2 to mix light L1 with each other. Thus, in the first area A1, the degradation in the display quality (illumination quality) caused by the non-uniformity in the luminance of illumination light or the chromaticity deviation of illumination light can be prevented.

Similarly, in the region in which the second layer P2 is not provided in the first area A1, light L2 from the side surface SF3 is trapped in the light guide LG2, and the incidence of the light on the display panel PNL is prevented. In the first area A1, light L2 from the light sources LS2 does not substantially enter the display panel PNL while light L1 from the light sources LS1 illuminates the display panel PNL. The second area A2 is sufficiently far from the side surface SF3 to mix light L2 with each other. Thus, in the second area A2, the degradation in the display quality (illumination quality) caused by the non-uniformity of illumination light can be prevented.

Further, the first layer P1 extends to the second area A2 beyond center C1 (the boundary between the first area A1 and the second area A2), and the second layer P2 extends to the first area A1 beyond center C1. Thus, a situation in which the luminance level of the emitted light of the illumination device IL is decreased near center C1 can be avoided. When each of the end portion E10 of the first layer P1 and the end portion E20 of the second layer P2 is located in center C1, there is a possibility that the luminance level of the emitted light of the illumination device IL is decreased near center C1.

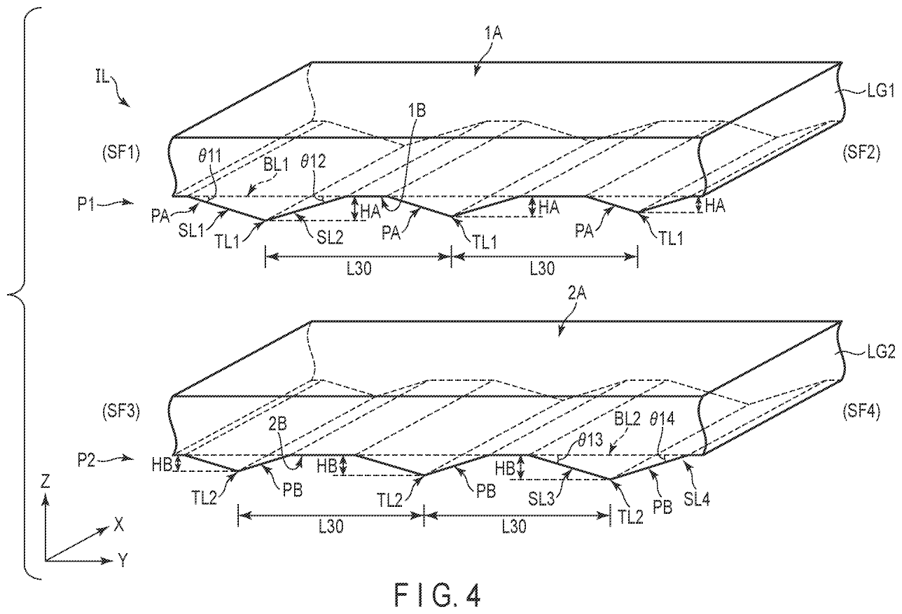

FIG. 4 is a diagram for explaining the shapes of the first layer P1 and the second layer P2 and is a perspective view of the illumination device IL shown in FIG. 3. FIG. 4 only shows, of the illumination device IL, part of the light guide LG1, part of the light guide LG2, part of the first layer P1 and part of the second layer P2.

As shown in FIG. 4, the first layer P1 comprises a plurality of prisms PA. The first layer P1 consists of a plurality of prisms PA which are intermittently arranged in direction Y. The second layer P2 comprises a plurality of prisms PB. The second layer P2 consists of a plurality of prisms PB which are intermittently arranged in direction Y. The prisms PA are provided in the main surface 1B. The prisms PB are provided in the main surface 2B. For example, the prisms PA are formed integrally with the light guide LG1. Similarly, the prisms PB are formed integrally with the light guide LG2.

The prisms PA protrude from the main surface 1B to the main surface 2A. Regarding each prism PA, the cross-sectional shape parallel to the Y-Z plane is a triangle, and each prism PA extends in direction X. For example, regarding the prisms PA, the cross-sectional shapes parallel to the Y-Z plane are similar to each other. Each prism PA comprises a slope SL1, a slope SL2, a reference plane BL1, an intersection line TL1 and height HA.

The slope SL1 is located on the side surface SF1 side. The slope SL2 is located on the side surface SF2 side. The reference plane BL1 is located on the same plane as the main surface 1B. The intersection line TL1 is the line of intersection of the slope SL1 and the slope SL2.

A plurality of intersection lines TL1 are arranged at regular intervals L30 in direction Y. Interval L30 is, for example, 0.1 mm. In the example shown in the figure, angle θ11 between the slope SL1 and the reference plane BL1 is equal to angle θ12 between the slope SL2 and the reference plane BL1. It should be noted that angle θ11 corresponds to one of the interior angles on the section of each prism PA, and angle θ12 corresponds to another one of the interior angles on the section of the prism PA. The section of the prism PA is an isosceles triangle. Height HA is the height of the prism PA in the normal direction of the main surface 1B and corresponds to the length from the reference plane BL1 to the intersection line TL1 in direction Z.

Height HA of each prism PA is decreased from the side surface SF1 to the side surface SF2. In other words, height HA of each prism PA increases with increasing distance from the light sources LS1. From the end portion E10 to the end portion E11, the proportion of the prisms PA (reference planes BL1) per unit area in the X-Y plane is increased, and the proportion of the main surface 1B per unit area in the X-Y plane is decreased. Meanwhile, when the light which travels inside the light guide LG1 goes to the prisms PA of the first layer P1 and is emitted from the light guide LG1, the amount of the light which travels inside the light guide LG1 is decreased. By this configuration, the illumination device IL can emit illumination light having a uniform luminance distribution to the display panel PNL in the first area A1.

Each prism PB protrudes from the main surface 2B in direction Z and extends in direction X. Regarding each prism PB, the cross-sectional shape parallel to the Y-Z plane is a triangle. In the example shown in the figure, the cross-sectional shapes of the prisms PB are similar to each other. Each prism PB comprises a slope SL3, a slope SL4, a reference plane BL2, an intersection line TL2 and height HB. The slope SL3 is located on the side surface SF3 side. The slope SL4 is located on the side surface SF4 side. The reference plane BL2 is located on the same plane as the main surface 2B. The intersection line TL2 is the line of intersection of the slope SL3 and the slope SL4. A plurality of intersection lines TL2 are arranged at regular intervals L30 in direction Y. In the example shown in the figure, angle θ13 between the slope SL3 and the reference plane BL2 is equal to angle θ14 between the slope SL4 and the reference plane BL2. It should be noted that angle θ13 corresponds to one of the interior angles on the section of each prism PB, and angle θ14 corresponds to another one of the interior angles on the section of the prism PB. The section of the prism PB is an isosceles triangle. Height HB is the height of the prism PB in the normal direction of the main surface 2B and corresponds to the length from the reference plane BL2 to the intersection line TL2 in direction Z.

Height HB of each prism PB is decreased from the side surface SF4 to the side surface SF3. In other words, height HB of each prism PB increases with increasing distance from the light sources LS2. From the side surface SF4 to the side surface SF3, the proportion of the prisms PB (reference planes BL2) per unit area in the X-Y plane is decreased, and the proportion of the main surface 2B per unit area in the X-Y plane is increased. Meanwhile, when the light which travels inside the light guide LG2 goes to the prisms PB of the second layer P2 and is emitted from the light guide LG2, the amount of the light which travels inside the light guide LG2 is decreased. By this configuration, the illumination device IL can emit illumination light having a uniform luminance distribution to the display panel PNL in the second area A2.

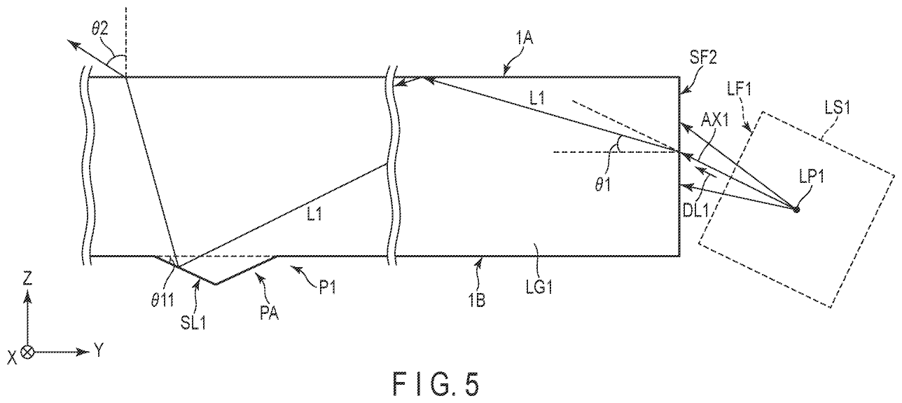

FIG. 5 is a fragmentary sectional view of the light guide LG1, first layer P1 and light source LS1 shown in FIG. 3. As shown in FIG. 5, the light source LS1 comprises a light emitting point LP1 and an emission surface LF1. The light emitting point LP1 is the point from which light L1 comprising optical axis AX1 parallel to emission direction DL1 is emitted. Light L1 emitted from the light emitting point LP1 travels while diffusing. The emission surface LF1 corresponds to, for example, the external surface of the light source LS1.

Emission direction DL1 inclines with respect to direction Y and direction Z. Emission direction DL1 is not orthogonal to the side surface SF2. In other words, emission direction DL1 intersects with the normal direction of the side surface SF2. By this configuration, light L1 is refracted when it enters the light guide LG1. The angle θ1 of incidence of light L1 on the light guide LG1 is less than the angle between emission direction DL1 and direction Y. For example, incidence angle θ1 is equal to angle θ11.

In the example shown in the figure, light L1 which has traveled inside the light guide LG1 is reflected on the slope SL1 of the prism PA. Light L1 reflected on the slope SL1 is refracted on the interface between the main surface 1A and an air layer as it is out of the conditions for the total reflection of the main surface 1A. This light L1 is emitted from the main surface 1A at emission angle θ2. Emission angle θ2 is the angle between the light emitted from the main surface 1A and the normal of the main surface 1A. The refractive index of each of the light guide LG1 and the light guide LG2 is n.

The following relational equation is established among angle θ11 of the prism PA, emission angle θ2 and refractive index n.

$$θ 11 = \frac{1}{3} ( 90 - {sin}^{- 1} ( \frac{1}{n} sin θ2 ) )$$

A structure similar to that of FIG. 5 can be applied to the side surface SF3 and the light source LS2. In other words, emission direction DL2 of the light source LS2 is not orthogonal to the side surface SF3, and emission direction DL2 intersects with the normal direction of the side surface SF3. It should be noted that the structure of the side surface SF3 and the light source LS2 may be different from that of FIG. 5.

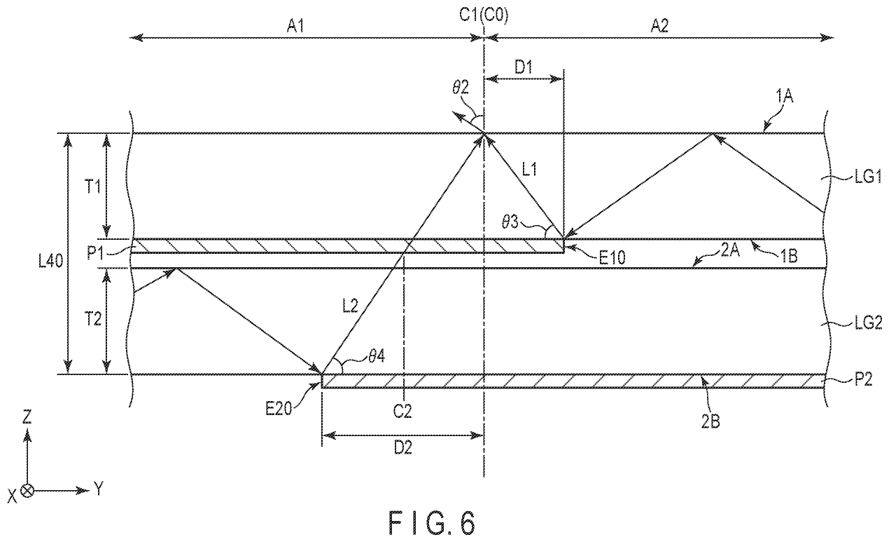

FIG. 6 is a cross-sectional view of the illumination device IL near centers C1 and C2. As shown in FIG. 6, the first layer P1 has length D1 in the second area A2. Length D1 corresponds to the distance from center C1 to the end portion E10 in direction Y.

The second layer P2 has length D2 in the first area A1. Length D2 corresponds to the distance from center C1 to the end portion E20 in direction Y. Length D2 is greater than length D1. In the example shown in the figure, length D2 is equal to twice length D1. The distance between center C1 and center C2 in direction Y is equal to length D1. It should be noted that the relationship between length D1 and length D2 is not limited to the example shown here.

The following relational equation is established among length D1, thickness T1, emission angle θ2 and refractive index n.

$$D 1 = 2 \times T 1 \times tan ( {sin}^{- 1} ( \frac{1}{n} sin θ 2 ) )$$

Length L40 shown in FIG. 6 is the distance from the main surface 2B to the main surface 1A in direction Z. The distance between the main surface 1B and the main surface 2A is extremely less than thickness T1 and thickness T2. Thus, length L40 is substantially equal to the sum of thickness T1 and thickness T2 (or twice thickness T1). In the present embodiment, the phase “substantially equal to” includes a case where the two distances, thicknesses, lengths, etc., compared to each other are different from each other within an error of several percent in addition to a case where they are completely the same as each other.

In the example shown in the figure, the angle between light L1 reflected on the end portion E10 of the first layer P1 (the prism PA closest to the side surface SF2) and the main surface 1B is θ3. The angle between light L2 reflected on the end portion E20 of the second layer P2 (the prism PB closest to the side surface SF3) and the main surface 2B is θ4. In the present embodiment, angle θ3 and angle θ4 are acute angles and are equal to each other.

In the present embodiment, the first layer P1 has length D1 in the second area A2, and the second layer P2 has length D2 in the first area A1. Light L1 which has traveled inside the light guide LG1 is emitted from the main surface 1A in center C1 by the prism PA located in the end portion E10. Light L2 which has traveled inside the light guide LG2 is emitted from the main surface 1A in center C1 by the prism PB located in the end portion E20. By this configuration, the illumination device IL can emit illumination light with a uniform luminance even near center C1 compared with a case where the first layer P1 does not extend to the second area A2 or the second layer does not extend to the first area A1.

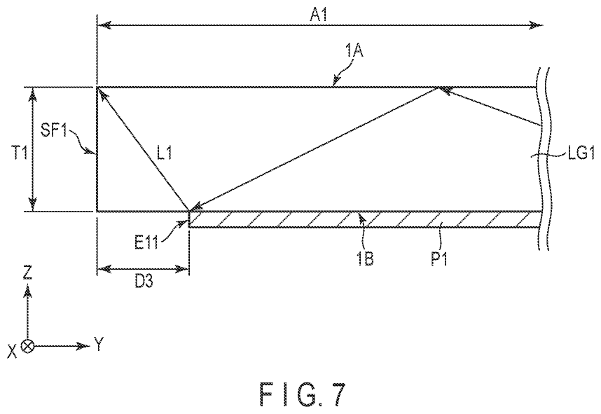

FIG. 7 is a cross-sectional view of the first layer P1 and the light guide LG1 near the side surface SF1. As shown in FIG. 7, the end portion E11 of the first layer P1 is length D3 distant from the side surface SF1 in direction Y. The following relational equation is established among length D3, thickness T1, emission angle θ2 and refractive index n.

$$D 3 = T 1 \times tan ( {sin}^{- 1} ( \frac{1}{n} sin θ 2 ) )$$

In the example shown in the figure, light L1 which has reached the end portion E11 is reflected on the first layer P1 (the prism PA closest to the side surface SF1), and subsequently travels to the main surface 1A without hitting against the side surface SF1. If light L1 reflected on the first layer P1 is reflected on the side surface SF1 and emitted from the main surface 1A, the luminance of the illumination light of the illumination device IL could be locally high near the side surface SF1. Such a situation can be avoided by the configuration of the present embodiment.

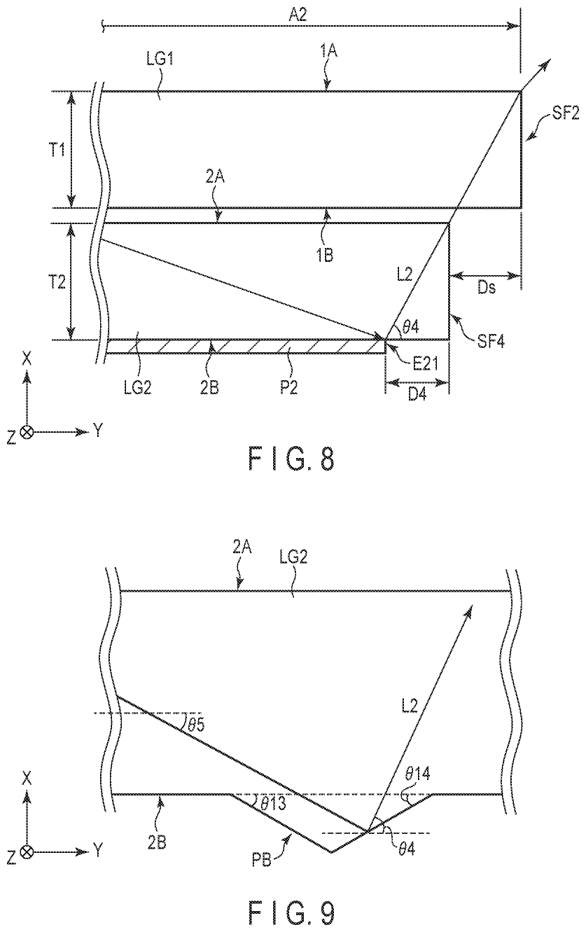

FIG. 8 is a cross-sectional view of the first layer P1, the second layer P2, the light guide LG1 and the light guide LG2 near the side surface SF2 and the side surface SF4. As shown in FIG. 8, the end portion E21 of the second layer P2 is length D4 distant from the side surface SF4 in direction Y. For example, a relationship similar to the above relational equation of length D3 is established among length D4, thickness T2, emission angle θ2 of the main surface 2A and refractive index n of the light guide LG2. In the present embodiment, length D3 is equal to length D4.

The side surface SF2 protrudes relative to the side surface SF4 by distance Ds in direction Y. Distance Ds corresponds to the distance between the side surface SF2 and the side surface SF4 in direction Y. Although not shown in FIG. 8, the side surface SF3 of the light guide LG2 protrudes relative to the side surface SF1 of the light guide LG1 by a length substantially equal to distance Ds in direction Y.

Light L2 reflected on the end portion E21 of the second layer P2 (the prism PB closest to the side surface SF4) makes angle θ4 with the main surface 2B.

FIG. 9 is a cross-sectional view of the light guide LG2 for explaining angle θ4 and shows the optical path of light L2 reflected on the prism PB. As shown in FIG. 4, the prism PB has the same interior angles θ13 and θ14. The angle of incidence of light L2 on the light guide LG2 is defined as θ5. Incidence angle θ5 is substantially equal to, for example, incidence angle θ1 of light L1 on the light guide LG1. The light which reaches the prism PB after repetitive reflection inside the light guide LG2 also inclines with respect to the main surface 2B at incidence angle θ5. In this case, θ4=2×θ14+θ5.

In the present embodiment, light L2 shown in FIG. 8 is not reflected on the side surface SF2 and is directly emitted from the main surface 1A. In this case, for example, assuming that the length of the gap between the light guide LG1 and the light guide LG2 is extremely less than thickness T1, the following relational equation is established.

$$D s \geq ( \frac{T 1}{tan θ 4} )$$

If distance Ds is great, a non-light-emitting area could be formed in the main surface 1A near the side surface SF2. To prevent this problem, distance Ds should be desirably less than thickness T1. More desirably, distance Ds should be equal to the right side (T1/tan θ4) of the above relational equation.

Here, examples of the effects obtained from the present embodiment are explained.

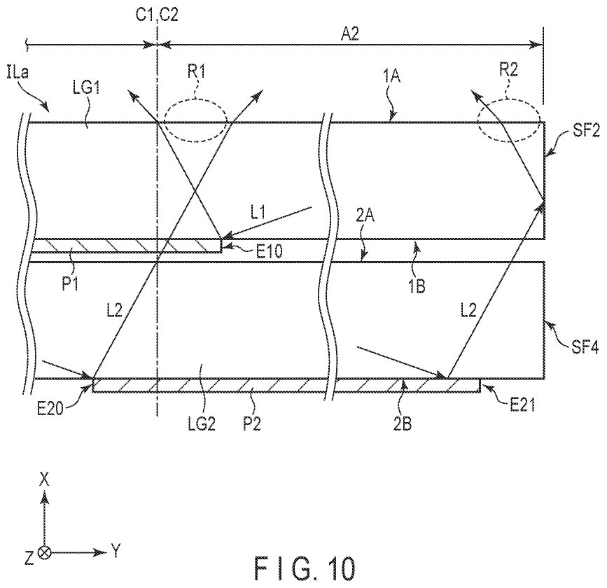

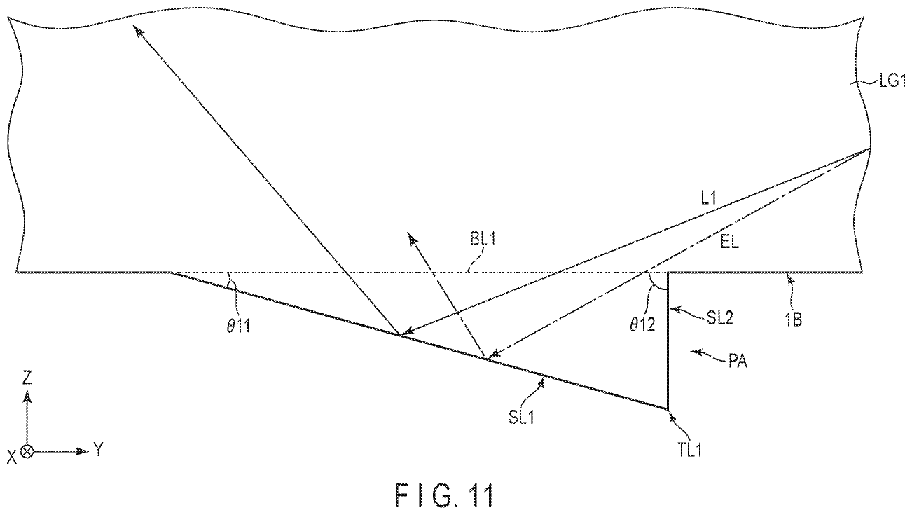

FIG. 10 is a cross-sectional view of an illumination device ILa according to a comparative example. In a manner similar to that of the illumination device IL of the present embodiment, the illumination device ILa comprises a light guide LG1, a light guide LG2, a first layer P1 and a second layer P2. In the illumination device ILa, the position of the first layer P1 in the light guide LG1 and the position of the second layer P2 in the light guide LG2 are the same as the illumination device IL.

In the illumination device ILa, the light guide LG1 and the light guide LG2 are not displaced from each other in direction Y. In other words, center C1 of the light guide LG1 is coincident with center C2 of the light guide LG2. The positions of a side surface SF2 and a side surface SF4 in direction Y are also coincident with each other.

Now, this specification assumes a case where the light guide LG1 including the first layer P1 has the same shape as the light guide LG2 including the second layer P2, and further, light L1 reflected on an end portion E10 is emitted from center C1 of a main surface 1A. In this case, light L2 reflected on an end portion E20 is emitted from a position which is closer to the side surface SF2 than center C1 in the main surface 1A. Thus, area R1 in which the luminance is less than that of the vicinity could be formed in the main surface 1A near center C1.

In this comparative example, light L2 reflected on the second layer P2 near an end portion E21 is reflected on the side surface SF2 and is subsequently emitted from the main surface 1A. In this case, area R2 in which the luminance is higher than that of the vicinity could be formed in the main surface 1A near the side surface SF2.

To the contrary, in the configuration of the present embodiment, as explained with reference to FIG. 6, the luminance of illumination light can be uniformized even near center C1. Further, as explained with reference to FIG. 8, when the reflection of light L2 on the side surface SF2 is prevented, the luminance of illumination light can be uniformized even near the side surface SF2.

In addition, in the present embodiment, the uniformity of luminance is realized by shifting the position of the light guide LG1 from the position of the light guide LG2 in direction Y. In this case, the light guide LG1 including the first layer P1 can be formed into the same shape as the light guide LG2 including the second layer P2. As these light guides LG1 and LG2 can be manufactured by the same mold, the manufacturing processes of the illumination device IL and the display device DSP can be simplified, and the manufacturing cost can be also reduced.

Direction Y corresponds to the direction of the long sides of the light guide LG1 and the light guide LG2. In other words, in the present embodiment, a plurality of light sources LS1 are arranged in the direction of the short sides of the light guide LG1 (direction X) and emit light in the direction of the long sides. A plurality of light sources LS2 are arranged in the direction of the short sides of the light guide LG2 and emit light in the direction of the long sides. In this case, a sufficient distance which can spread light in the direction of the short sides can be ensured between the light sources LS1 and the first area A1 and between the light sources LS2 and the second area A2. The effect of preventing non-uniformity in luminance can be obtained by shifting the position of the light guide LG1 from the position of the light guide LG2 in the direction of the long sides.

In the present embodiment, direction Y is an example of a first direction, and direction X is an example of a second direction. Each light source LS1 is an example of a first light source, and each light source LS2 is an example of a second light source. The light guide LG1 is an example of a first light guide, and the light guide LG2 is an example of a second light guide. The main surface 1A is an example of a first main surface. The main surface 1B is an example of a second main surface. The main surface 2A is an example of a third main surface. The main surface 2B is an example of a fourth main surface. The side surface SF1 to the side surface SF4 are examples of a first side surface to a fourth side surface, respectively. Each prism PA is an example of a first prism, and each prism PB is an example of a second prism. The end portion E10 is an example of a first end portion. The end portion E11 is an example of a second end portion. The end portion E20 is an example of a third end portion. The end portion E21 is an example of a fourth end portion.

FIG. 11 is a cross-sectional view showing a modified example of the present embodiment. As shown in FIG. 11, the prism PA of the modified example is different from the prism PA of the present embodiment described above in respect that angle θ11 is not equal to angle θ12. Angle θ12 is greater than angle θ11. In the example shown in the figure, angle θ12 is 90 degrees, and the Y-Z section of the prism PA is a right triangle. The area of the slope SL1 is greater than that of the slope SL2.

Light L1 which travels inside the light guide LG1 travels inside the light guide LG1 while diffusing. Diffused light EL shown in FIG. 11 corresponds to the light which diffuses from light L1. In the modified example shown in the figure, the area of the slope SL1 is increased compared with the case where the section of the prism PA is an isosceles triangle as shown in FIG. 5. Thus, the possibility that diffused light EL is reflected on the slope SL1 of the prism PA is increased, and the luminance of the illumination light of the illumination device IL can be increased.

A structure similar to that of FIG. 11 can be applied to the prism PB. In other words, angle θ14 is greater than angle θ13. The area of the slope SL4 is greater than that of the slope SL3.

As explained above, the present embodiment can provide the illumination device IL which can prevent the non-uniformity in the luminance of illumination light. Further, when this illumination device IL is used, the display quality of the display device DSP can be also improved.

All of the illumination devices and display devices that can be implemented by a person of ordinary skill in the art through arbitrary design changes to the illumination device and display device described above as the embodiments of the present invention come within the scope of the present invention as long as they are in keeping with the spirit of the present invention.

Various modification examples which may be conceived by a person of ordinary skill in the art in the scope of the idea of the present invention will also fall within the scope of the invention. For example, even if a person of ordinary skill in the art arbitrarily modifies the above embodiments by adding or deleting a structural element or changing the design of a structural element, or by adding or omitting a step or changing the condition of a step, all of the modifications fall within the scope of the present invention as long as they are in keeping with the spirit of the invention.

Further, other effects which may be obtained from the above embodiments and are self-explanatory from the descriptions of the specification or can be arbitrarily conceived by a person of ordinary skill in the art are considered as the effects of the present invention as a matter of course.

What is claimed is:

1. An illumination device comprising:
a first light guide comprising a first main surface, a second main surface located on an opposite side of the first main surface, a first side surface, and a second side surface located on an opposite side of the first side surface in a first direction;
a second light guide comprising a third main surface facing the second main surface, a fourth main surface located on an opposite side of the third main surface, a third side surface which is close to the first side surface, and a fourth side surface which is located on an opposite side of the third side surface in the first direction and close to the second side surface;
a plurality of first light sources which face the second side surface and are arranged in a second direction intersecting with the first direction;
a plurality of second light sources which face the third side surface and are arranged in the second direction;
a first layer which includes a plurality of first prisms provided in the second main surface; and
a second layer which includes a plurality of second prisms provided in the fourth main surface, wherein
the second side surface and the fourth side surface are displaced from each other in the first direction.

2. The illumination device of claim 1, wherein
the second side surface protrudes from the fourth side surface in the first direction.

3. The illumination device of claim 2, wherein
a distance between the second side surface and the fourth side surface in the first direction is less than a thickness of the first light guide.

4. The illumination device of claim 1, wherein
the first layer overlaps the second layer in a center of the first main surface in the first direction.

5. The illumination device of claim 4, wherein
the first layer comprises a first end portion located between the center and the second side surface in the first direction, and a second end portion located between the center and the first side surface in the first direction,
the second layer comprises a third end portion located between the center and the third side surface in the first direction, and a fourth end portion located between the center and the fourth side surface in the first direction, and
a distance between the center and the third end portion in the first direction is greater than a distance between the center and the first end portion in the first direction.

6. The illumination device of claim 5, wherein
the second end portion is spaced apart from the first side surface in the first direction, and
the fourth end portion is spaced apart from the fourth side surface in the first direction.

7. The illumination device of claim 1, wherein
a length of the first light guide in the first direction is equal to a length of the second light guide in the first direction.

8. The illumination device of claim 1, wherein
a length of the first layer in the first direction is equal to a length of the second layer in the second direction.

9. The illumination device of claim 1, wherein
the first prisms are arranged in the first direction,
the second prisms are arranged in the first direction,
a height of each of the first prisms increases with increasing distance from the first light sources, and
a height of each of the second prisms increases with increasing distance from the second light sources.

10. The illumination device of claim 1, wherein
the first light sources and the second light sources are laser light sources.

11. A display device comprising:
an illumination device; and
a display panel which displays an image, wherein the illumination device comprises:
a first light guide comprising a first main surface, a second main surface located on an opposite side of the first main surface, a first side surface, and a second side surface located on an opposite side of the first side surface in a first direction;
a second light guide comprising a third main surface facing the second main surface, a fourth main surface located on an opposite side of the third main surface, a third side surface which is close to the first side surface, and a fourth side surface which is located on an opposite side of the third side surface in the first direction and close to the second side surface;
a plurality of first light sources which face the second side surface and are arranged in a second direction intersecting with the first direction;
a plurality of second light sources which face the third side surface and are arranged in the second direction;
a first layer which includes a plurality of first prisms provided in the second main surface; and
a second layer which includes a plurality of second prisms provided in the fourth main surface, wherein
the second side surface and the fourth side surface are displaced form each other in the first direction, and
the display panel faces the first main surface.

12. The display device of claim 11, wherein
the second side surface protrudes relative to the fourth side surface in the first direction.

13. The display device of claim 12, wherein
a distance between the second side surface and the fourth side surface in the first direction is less than a thickness of the first light guide.

14. The display device of claim 11, wherein
the first layer overlaps the second layer in a center of the first main surface in the first direction.

15. The display device of claim 14, wherein
the first layer comprises a first end portion located between the center and the second side surface in the first direction, and a second end portion located between the center and the first side surface in the first direction,
the second layer comprises a third end portion located between the center and the third side surface in the first direction, and a fourth end portion located between the center and the fourth side surface in the first direction, and
a distance between the center and the third end portion in the first direction is greater than a distance between the center and the first end portion in the first direction.

16. The display device of claim 15, wherein
the second end portion is spaced apart from the first side surface in the first direction, and
the fourth end portion is spaced apart from the fourth side surface in the first direction.

17. The display device of claim 11, wherein
a length of the first light guide in the first direction is equal to a length of the second light guide in the first direction.

18. The display device of claim 11, wherein
a length of the first layer in the first direction is equal to a length of the second layer in the second direction.

19. The display device of claim 11, wherein
the first prisms are arranged in the first direction,
the second prisms are arranged in the first direction,
a height of each of the first prisms increases with increasing distance from the first light sources, and
a height of each of the second prisms increases with increasing distance from the second light sources.

20. The display device of claim 11, wherein
the first light sources and the second light sources are laser light sources.
